(19) United States
(12) Patent Application Publication
(10) Pub. No.: US 2026/0228945 A1
(43) Pub. Date: Aug. 6, 2026

(54) COVER SETTING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Wanli CHE, Beijing (CN); Hao LIN, Beijing (CN)

(21) Appl. No.: 19/149,489

(22) PCT Filed: May 30, 2024
(86) PCT No.: PCT/CN2024/096303

§ 371 Date: Jul. 18, 2025

(30) Foreign Application Priority Data
Jun. 29, 2023 (CN) 202310788253.9

(51) Int. Cl. G06T 11/60; G06F 3/0482; G06F 3/0483; G06F 3/04845

(52) U.S. Cl. CPC G06T 11/60; G06F 3/0482; G06F 3/0483; G06F 3/04845

(57) ABSTRACT

A cover setting method and apparatus, an electronic device, and a storage medium are provided. The method includes: presenting a cover list of a work to be posted, where the cover list presents cover information of at least one candidate cover that is obtained by performing image processing on at least part of work images of the work to be posted; and setting a first candidate cover in the at least one candidate cover as a work cover of the work to be posted, in response to a cover setting operation for the first candidate cover.

The present application claims priority to Chinese Patent Application No. 202310788253.9, filed on Jun. 29, 2023, the disclosure of which is incorporated herein by reference in its entirety.

### TECHNICAL FIELD

The present disclosure relates to a cover setting method and apparatus, an electronic device, and a storage medium.

### BACKGROUND

At present, before posting a work, a user can set a cover for the work to be posted. For example, the user may obtain a work image of the work to be posted, edit the obtained work image as needed, and set the edited work image as the cover of the work to be posted.

However, in the conventional technology, the operation for the user to set a cover is relatively complex and difficult, making it inconvenient for the user to set the cover quickly.

### SUMMARY

Embodiments of the present disclosure provide a cover setting method and apparatus, an electronic device, and a storage medium, to simplify operations needed for cover setting, and reduce the difficulty of cover setting.

According to a first aspect, embodiments of the present disclosure provides a cover setting method. The cover setting method includes:
presenting a cover list of a work to be posted, where the cover list presents cover information of at least one candidate cover that is obtained by performing image processing on at least part of work images of the work to be posted; and
setting a first candidate cover in the at least one candidate cover as a work cover of the work to be posted, in response to a cover setting operation for the first candidate cover.

According to a second aspect, embodiments of the present disclosure further provides a cover setting apparatus. The cover setting apparatus includes:
a list presentation module configured to present a cover list of a work to be posted, where the cover list presents cover information of at least one candidate cover that is obtained by performing image processing on at least part of work images of the work to be posted; and
a cover setting module configured to set a first candidate cover in the at least one candidate cover as a work cover of the work to be posted, in response to a cover setting operation for the first candidate cover.

According to a third aspect, embodiments of the present disclosure further provides an electronic device. The electronic device includes:
one or more processors; and
a memory configured to store one or more programs, where
the one or more programs, when executed by the one or more processors, cause the one or more processors to implement the cover setting method according to the embodiments of the present disclosure.

According to a fourth aspect, embodiments of the present disclosure further provides a computer-readable storage medium storing a computer program, and the program, when executed by a processor, causes the processor to implement the cover setting method according to the embodiments of the present disclosure.

### BRIEF DESCRIPTION OF DRAWINGS

The foregoing and other features, advantages, and aspects of embodiments of the present disclosure become more apparent with reference to the following specific implementations and drawings. Throughout the drawings, the same or similar reference numerals denote the same or similar elements. It should be understood that the drawings are schematic and that parts and elements are not necessarily drawn to scale.

FIG. 1 is a schematic flowchart of a cover setting method according to embodiments of the present disclosure;

FIG. 2 is a schematic diagram of presentation of a cover list according to embodiments of the present disclosure;

FIG. 3 is a schematic diagram of presentation of another cover list according to embodiments of the present disclosure;

FIG. 4 is a schematic diagram of presentation of yet another cover list according to embodiments of the present disclosure;

FIG. 5 is a schematic diagram of display of a posting page according to embodiments of the present disclosure;

FIG. 6 is a schematic diagram of display of an image selection page according to embodiments of the present disclosure;

FIG. 7 is a schematic diagram of display of another posting page according to embodiments of the present disclosure;

FIG. 8 is a schematic flowchart of another cover setting method according to embodiments of the present disclosure;

FIG. 9 is a schematic diagram of presentation of a cover selection page according to embodiments of the present disclosure;

FIG. 10 is a schematic diagram of display of a first editing page according to embodiments of the present disclosure;

FIG. 11 is a schematic diagram of display of a second editing page according to embodiments of the present disclosure;

FIG. 12 is a structural block diagram of a cover setting apparatus according to embodiments of the present disclosure; and

FIG. 13 is a schematic structural diagram of an electronic device according to embodiments of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above-described process of notifying and obtaining the authorization of the user is only illustrative and does not constitute a limitation on the implementations of the present disclosure, and other manners that satisfy the relevant laws and regulations may also be applied in the implementations of the present disclosure.

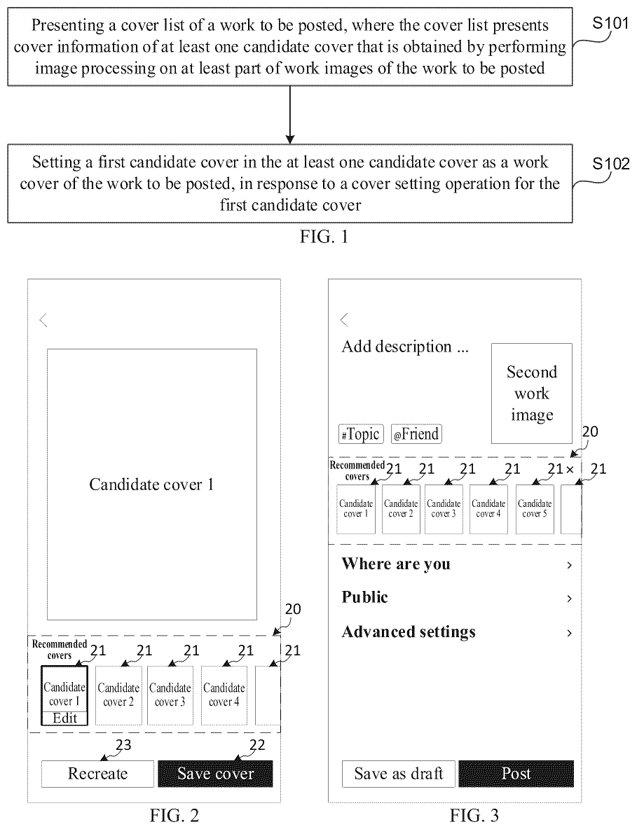

FIG. 1 is a schematic flowchart of a cover setting method according to embodiments of the present disclosure. The method may be performed by a cover setting apparatus. The apparatus may be implemented by software and/or hardware, and may be configured in an electronic device, such as a mobile phone or a tablet computer. The cover setting method provided in this embodiment of the present disclosure is applicable to a scenario of setting a cover for a work to be posted. As shown in FIG. 1, the cover setting method provided in this embodiment may include the following steps.
S101: presenting a cover list of a work to be posted, where the cover list presents cover information of at least one candidate cover that is obtained by performing image processing on at least part of work images of the work to be posted.

The work to be posted may be a work to be posted by a user, such as a work that the user wants to post currently. The type of the work is not limited. For example, the work may be video content or captioned graphic content. The cover list may be understood as a list of covers of the work to be posted that are available for the user to select. The cover list presents the cover information of the at least one candidate cover.

The candidate cover may be a cover obtained by performing image processing on at least part of the work images of the work to be posted. The candidate cover is a processed cover for the user to select, which is different from the work image of the work to be posted. Taking the work to be posted being a video as an example, the candidate cover may be obtained by performing image processing on one or more video frames of the work to be posted. The image processing may include, for example, image beautification, adding a cover template, and/or adding cover script.

For example, the work to be posted may be parsed, and key work images (such as key frames) of the work to be posted are selected based on work content of the work to be posted. For each key work image, the key work image is beautified with respect to solutions such as color and image quality, etc. A cover template is matched for the beautified key work image, and the beautified key work image is added to the matched cover template. Image content of the key work image is recognized, and cover script corresponding to the key work image is generated. The generated cover script is added to the key work image for which the cover template has been added, and the cover script is intelligently laid out to obtain a candidate cover of the work to be posted. The cover script may be considered as separately added script in addition to the cover template. For example, the cover template may or may not carry template script, and the script may be different from the template script.

It should be noted that different candidate covers may be obtained by processing the same or different work images of the work to be posted. For example, different work images of the work to be posted may be processed using the same or different beautification manners, cover templates, or cover script, to obtain different candidate covers of the work to be posted; and/or a work image of the work to be posted is processed using different beautification manners, different cover templates, and/or different cover script, to obtain different candidate covers of the work to be posted.

Cover information of the candidate cover may be considered as related information of the candidate cover, such as identification information or description information of the candidate cover. For example, the cover information of the candidate cover may include a thumbnail of the candidate cover.

Specifically, as shown in FIG. 2 to FIG. 4, a cover list 20 of a work to be posted may be presented, and the cover list 20 presents cover information 21 of at least one candidate cover that is obtained by performing image processing on work images of the work to be posted, for the user to view and select.

In this embodiment, at least part of the work images may be pre-selected from the work to be posted by the user, and image processing is performed on the at least part of the work images, to generate the candidate covers of the work to be posted. Therefore, the user may select a candidate cover as the work cover of the work to be posted. Compared with the technical solution in which a work image of a work to be posted (such as the first frame of work image) is used by default as a cover of the work to be posted, or the technical solution in which a user needs to select, from work images of a work to be posted, a work image to be used to generate a cover, and selects a suitable image processing manner to process the selected work image to obtain the cover of the work to be posted, this embodiment can simplify operations needed for cover setting, reduce the difficulty of cover setting, and improve the quality of the set cover.

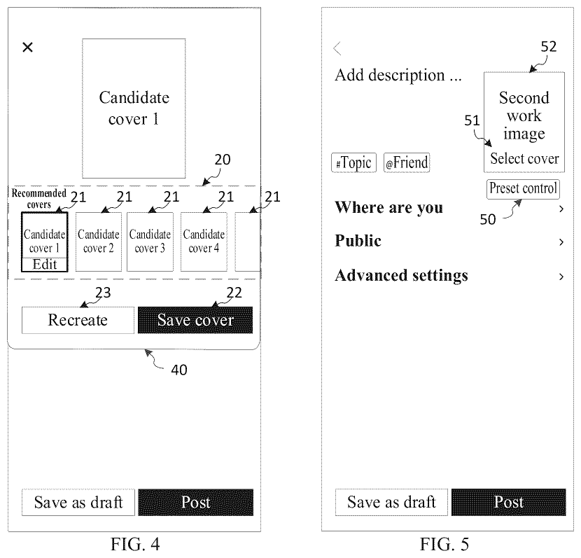

In this embodiment, a presentation position of the cover list may be set as needed. For example, the cover list may be presented on a cover selection page (as shown in FIG. 2) and/or a posting page (as shown in FIG. 3 and FIG. 4) of the work to be posted. In this case, optionally, the presenting the cover list of the work to be posted includes at least one selected from a group consisting of the following: displaying a cover selection page of the work to be posted, and presenting the cover list of the work to be posted on the cover selection page; or presenting the cover list of the work to be posted on a posting page of the work to be posted. The cover selection page may be a page used to present and allow the user to select the candidate cover obtained by image processing, which may be different from a work editing page and the posting page of the work to be posted.

A manner of presenting the cover list on the cover selection page and/or the posting page is not limited. Taking the cover list being presented on the posting page as an example, the cover list of the work to be posted may be presented as a non-floating layer on the posting page of the work to be posted. For example, the cover list and posting information on the posting page are presented on the same layer of the posting page, as shown in FIG. 3. The cover list of the work to be posted may alternatively be presented as a floating layer on the posting page of the work to be posted. For example, the cover list may be presented above the posting information presented on the posting page, as shown in FIG. 4. When presented on the same layer, the cover list and the posting information may be presented in different areas of the posting page. When presented on different layers, the cover list and the posting information may be presented in the same or different areas of the posting page. In this case, optionally, the posting page further presents posting information of the work to be posted, and the cover list and the posting information are presented in different areas or on different layers of the posting page.

The posting information of the work to be posted may be considered as original page content of the posting page other than the content related to the cover list. The posting information, for example, is page content used to perform posting setting on the work to be posted. The original page content may include, for example, a description information input area of information to be posted, and a topic adding control, a friend @ control, a location setting control, an audience and visibility setting control, an advanced setting control, a save control, and/or a post control of the information to be posted, etc.

When the cover list 20 of the work to be posted is presented on the posting page of the work to be posted as the floating layer, for example, a cover selection panel 40 may be presented above the posting information presented on the posting page, and the cover list 20 of the work to be posted may be presented on the cover selection panel 40, as shown in FIG. 4.

In some implementations, the displaying a cover selection page of the work to be posted includes: displaying the posting page of the work to be posted; and switching a current page from the posting page to the cover selection page of the work to be posted, in response to a first trigger operation performed on the posting page.

The first trigger operation may be a trigger operation for indicating to present the cover selection page of the work to be posted. The first trigger operation may be performed on the posting page. For example, the first trigger operation may be an operation of triggering a first preset control displayed on the posting page.

For example, a preset control 50 may be presented on the posting page. The preset control 50 may include, for example, the first preset control. Therefore, when it is detected that the user triggers the first preset control, it may be determined that the first trigger operation is received, and in response to the first trigger operation, the current page is switched from the posting page of the work to be posted to the cover selection page of the work to be posted. The cover list 20 of the work to be posted is presented on the cover selection page, and the cover list 20 presents cover information 21 of at least one candidate cover of the work to be posted, as shown in FIG. 2.

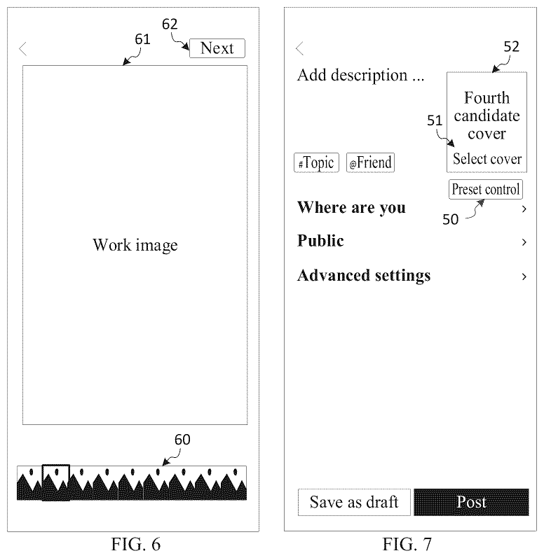

In the above-described implementation, the posting page of the work to be posted may or may not present an image selection control 51. The image selection control 51 may be considered as a control for triggering presentation of an image selection page of the work to be posted. For example, as shown in FIG. 5, for the case where the image selection control 51 is presented on the posting page, when it is detected that the user triggers the image selection control 51, the current page may be switched from the posting page of the work to be posted to the image selection page of the work to be posted, as shown in FIG. 6.

As shown in FIG. 6, the image selection page may contain an image information presentation area 60 and an image preview area 61. The image information presentation area 60 may be used to present image information of work images of the work to be posted, for example, thumbnails of the work images of the work to be posted. The image preview area 61 may be used to present a preview image of the work image corresponding to the image information selected by the user in the image information presentation area 60.

In some implementations, the presenting the cover list of the work to be posted on a posting page of the work to be posted includes: displaying the posting page of the work to be posted, and presenting the cover list of the work to be posted on the posting page of the work to be posted, in response to a second trigger operation performed on the posting page; or, displaying the posting page of the work to be posted, in response to a display operation for the posting page of the work to be posted, and presenting the cover list of the work to be posted on the posting page of the work to be posted.

The second trigger operation may be understood as a trigger operation for indicating to present the cover list of the work to be posted on the posting page. The second trigger operation may be performed on the posting page of the work to be posted. For example, the second trigger operation may be an operation of triggering a second preset control displayed on the posting page. The display operation for the posting page of the work to be posted may be a trigger operation for indicating to display the posting page of the work to be posted, such as an operation for indicating to switch the current page from the work editing page or another page of the work to be posted to the posting page of the work to be posted, and a manner of performing the display operation is not limited.

In the above-described implementation, the cover list of the work to be posted may not be presented on the posting page when the posting page is initially displayed, and then the cover list of the work to be posted is presented on the posting page when a trigger operation for indicating to display the cover list of the work to be posted is received.

For example, as shown in FIG. 5, the posting page may be displayed, and the preset control 50 may be presented on the posting page. The preset control 50 may include, for example, the second preset control. When it is detected that the user triggers the second preset control presented on the posting page, it is determined that the second trigger operation is received and in response to the second trigger operation, the cover list 20 of the work to be posted is presented on the posting page. For example, the cover list 20 of the work to be posted is additionally presented on the posting page, as shown in FIG. 3. Alternatively, the cover selection panel 40 of the work to be posted is presented above the original page content presented on the posting page, and the cover list 20 of the work to be posted is presented on the cover selection panel 40, as shown in FIG. 4.

In the above-described implementation, the cover list of the work to be posted may alternatively be presented on the posting page when the posting page is displayed. For example, when the display operation for the posting page of the work to be posted is received, the posting page of the work to be posted may be displayed, and the cover list 20 of the work to be posted and the posting information of the work to be posted are presented on the posting page, as shown in FIG. 3.

In this embodiment, a generation occasion of the candidate cover of the work to be posted may be flexibly set. For example, the candidate cover of the work to be posted may be generated based on at least part of the work images of the work to be posted, when the display operation for the work editing page of the work to be posted is received or when the display operation for the posting page of the work to be posted is received. The work editing page may be understood as a page for editing work content of the work to be posted (not the cover of the work to be posted). The work content may include, for example, the work images and/or background music of the work to be posted.

In some implementations, the candidate cover of the work to be posted may be generated based on at least part of the work images of the work to be posted, when the display operation for the work editing page of the work to be posted is received, that is, in response to the display operation for the work editing page of the work to be posted. When the display operation for the posting page of the work to be posted is received, if the user does not edit the work to be posted on the work editing page of the work to be posted, the candidate cover of the work to be posted is no longer regenerated. If the user has edited the work to be posted on the work editing page of the work to be posted, the candidate cover of the work to be posted may be regenerated, in response to the display operation for the posting page of the work to be posted, based on the work images of the work to be posted that are edited by the user.

Therefore, when the trigger operation for indicating to display the cover list of the work to be posted (such as the first trigger operation, the second trigger operation, or the display operation for the posting page of the work to be posted) is received, if the generation of the candidate cover of the work to be posted is completed, the cover list of the work to be posted may be presented. If the generation of the candidate cover of the work to be posted is not completed, the cover list of the work to be posted may be presented after the generation of the candidate cover of the work to be posted is completed.

In this embodiment, the posting page may contain a work cover area, and the work cover area may be used to present a work cover currently set for the work to be posted.

Therefore, for the case where the user has not actively selected the cover information of any candidate cover, such as the case where the work editing page of the work to be posted is initially switched to the posting page of the work to be posted, a work image (such as a second work image) of the work to be posted may be selected by default as the work cover of the work to be posted, and the work cover may be presented in the work cover area 52 of the posting page, as shown in FIG. 5. Alternatively, a candidate cover (such as a fourth candidate cover) of the work to be posted may be selected by default as the work cover of the work to be posted, and the work cover set at that time is presented in the work cover area 52 of the posting page, as shown in FIG. 7. In this case, optionally, the displaying the posting page of the work to be posted includes: displaying the posting page of the work to be posted, and presenting a fourth candidate cover from the cover list in a work cover area of the posting page.

The second work image may be a work image of the work to be posted, such as a video frame or a picture of the work to be posted, and a determination logic of the second work image is not limited in this embodiment. The fourth candidate cover may be a candidate cover selected by default as the work cover of the work to be posted, which is a cover obtained by performing image processing on the work image of the work to be posted, and may be the same as or different from the first candidate cover.

In this embodiment, for the case where the fourth candidate cover of the work to be posted is selected by default as the work cover of the work to be posted as described above, if the generation of the fourth candidate cover of the work to be posted is completed when the posting page is displayed, the fourth candidate cover may be directly presented in the work cover area of the posting page, as shown in FIG. 7. If the generation of the candidate cover of the work to be posted is not completed when the posting page is displayed, the second work image of the work to be posted may be presented in the work cover area of the posting page, as shown in FIG. 5, and when the generation of the fourth candidate cover of the work to be posted is completed, the second work image presented in the work cover area is switched to the fourth candidate cover.

In the above-described implementation, for the case where the fourth candidate cover is set by default as the work cover of the work to be posted, cover information of the fourth candidate cover may be presented as selected in the cover list, when the cover list of the work to be posted is presented, and cover information other than the cover information of the fourth candidate cover in the cover list may be presented as unselected. In addition, the cover list may further present image information of the second work image, so that the user resets the second work image as the work cover of the work to be posted. In this case, optionally, the presenting the cover list of the work to be posted includes: presenting the cover list of the work to be posted, and presenting image information of a second work image of the work to be posted and the cover information of the at least one candidate cover in the cover list, where the image information of the second work image is used for a user to set the second work image as the work cover of the work to be posted, and cover information of the fourth candidate cover is presented as selected in the cover list.

Therefore, when it is detected that the user triggers the image information of the second work image presented in the cover list, the image information of the second work image may be presented as selected, and the cover information of the candidate covers presented in the cover list may be all presented as unselected. When a cover setting operation for the second work image is detected, the second work image is set as the work cover of the work to be posted.
S102: setting a first candidate cover in the at least one candidate cover as a work cover of the work to be posted, in response to a cover setting operation for the first candidate cover.

The cover setting operation may be considered as a trigger operation for indicating to set a candidate cover or a work image as the work cover of the work to be posted, such as the operation for triggering a cover saving control after cover information of a candidate cover or image information of a work image is selected, or the operation for triggering a cover saving control corresponding to a candidate cover. The first candidate cover may be a candidate cover corresponding to the cover setting operation. In other words, the cover setting operation indicates to set the first candidate cover as the candidate cover of the work cover of the work to be posted.

Specifically, when the cover setting operation for the first candidate cover is received, the first candidate cover may be set as the work cover of the work to be posted.

For example, when it is detected that the user triggers the cover saving control 22 (as shown in FIG. 2) presented on the cover selection page or the cover saving control 22 presented on the cover selection panel 40, the candidate cover as selected in the cover list 20 may be set as the work cover of the work to be posted.

Alternatively, when it is detected that the user triggers a candidate cover presented in the cover list, a cover saving control corresponding to the candidate cover may be displayed, and when it is detected that the user triggers the cover saving control, the candidate cover is set as the work cover of the work to be posted.

In addition, after the setting of the work cover of the work to be posted is completed, the user may post the work to be posted or save the work to be posted to a draft box according to personal needs.

The cover setting method provided in this embodiment includes presenting the cover list of the work to be posted, where the cover list presents the cover information of the at least one candidate cover that is obtained by preforming image processing on at least part of the work images of the work to be posted; and setting the first candidate cover in the at least one candidate cover as the work cover of the work to be posted, in response to the cover setting operation for the first candidate cover. In this embodiment, the above-described technical solution is used to provide the candidate cover that is obtained by performing image processing on the work images for the user to select, which can simplify operations needed for cover setting, reduce the difficulty of cover setting, and improve the quality of the set cover.

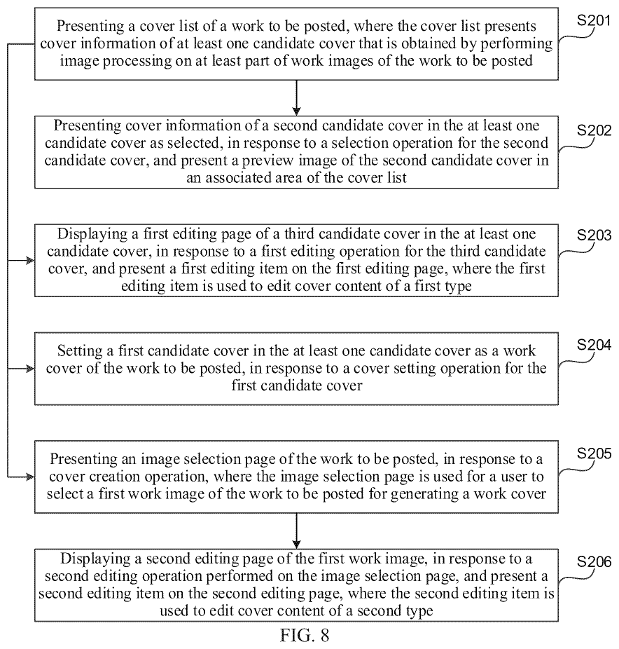

FIG. 8 is a schematic flowchart of another cover setting method according to embodiments of the present disclosure. The solution in this embodiment may be combined with one or more optional solutions in the above-described embodiments. Optionally, after the presenting a cover list of a work to be posted, the method further includes at least one selected from a group consisting of the following: presenting cover information of a second candidate cover in the at least one candidate cover as selected, in response to a selection operation for the second candidate cover, and presenting a preview image of the second candidate cover in an associated area of the cover list; displaying a first editing page of a third candidate cover in the at least one candidate cover, in response to the first editing operation for the third candidate cover, and presenting a first editing item on the first editing page, where the first editing item is used to edit cover content of a first type; or presenting an image selection page of the work to be posted, in response to a cover creation operation, where the image selection page is used for a user to select a first work image of the work to be posted for generating a work cover.

Optionally, after the presenting the image selection page of the work to be posted, the method further includes: displaying a second editing page of the first work image, in response to a second editing operation performed on the image selection page, and presenting a second editing item on the second editing page, where the second editing item is used to edit cover content of a second type.

Correspondingly, as shown in FIG. 8, the cover setting method provided in this embodiment may include the following steps.
S201: presenting a cover list of a work to be posted, and performing at least one selected from a group consisting of S202 to S205, where the cover list presents cover information of at least one candidate cover that is obtained by performing image processing on at least part of work images of the work to be posted.
S202: presenting cover information of a second candidate cover in the at least one candidate cover as selected, in response to a selection operation for the second candidate cover, and present a preview image of the second candidate cover in an associated area of the cover list.

The selection operation may be an operation for selecting a candidate cover, such as an operation for triggering cover information of a candidate cover presented in the cover list. The second candidate cover may be considered as a candidate cover currently selected by the user, which may be the same as or different from the first candidate cover. The associated area of the cover list may be an area used to present the preview image of the candidate cover as selected in the cover list, where the associated area may be located on a cover selection page or cover selection panel.

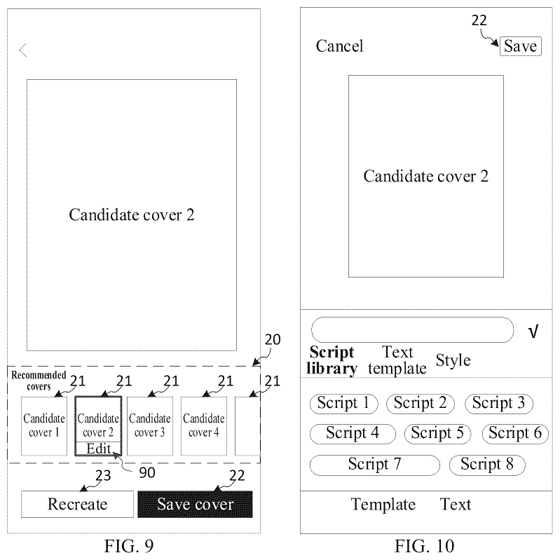

For example, when a selection operation for a candidate cover is received, for example, when it is detected that the user triggers cover information of a candidate cover presented in the cover list, the cover information of the candidate cover may be presented as selected, cover information other than the cover information of the candidate cover in the cover list is presented as unselected, and the preview image of the candidate cover is presented in the associated area of the cover list, as shown in FIG. 9 (FIG. 9 takes the triggering of the cover information of the candidate cover 2 on the cover selection page as an example).
S203: displaying a first editing page of a third candidate cover in the at least one candidate cover, in response to the first editing operation for the third candidate cover, and present a first editing item on the first editing page, where the first editing item is used to edit cover content of a first type.

The first editing operation may be a trigger operation for indicating to display a cover editing page of a candidate cover, such as an operation for triggering an editing control corresponding to a candidate cover. The third candidate cover may be considered as a candidate cover corresponding to the first editing operation, that is, the first editing operation indicates to present the candidate cover of the editing page of the third candidate cover, which may be the same as or different from the first candidate cover or the second candidate cover. The first editing page may be considered as a cover editing page of the third candidate cover, where the cover editing page may be used to edit and obtain a work cover of the work to be posted. The first editing item may be an editing item used to edit the cover content of the first type. The cover content of the first type may be set as needed. For example, the cover content of the first type may be text content of the cover, such as script content of the cover script added to the cover, a text template used for the cover script, and/or a presentation style of the cover script in the cover.

In this embodiment, when the first editing operation for a candidate cover is received, the first editing page of the candidate cover may be displayed, and the first editing item used to edit the cover content of the first type in the cover may be presented on the first editing page.

For example, when cover information 21 of a candidate cover is switched from unselected to selected, an editing control 90 corresponding to the candidate cover to which the cover information 21 as selected belongs may be further presented, as shown in FIG. 9 (this figure takes the presentation of the editing control 90 corresponding to the candidate cover 2 as an example). Therefore, when it is detected that the user triggers the editing control 90, the first editing page of the candidate cover corresponding to the editing control 90 may be presented, and the first editing item may be presented on the first editing page, as shown in FIG. 10 (this figure takes the first editing item being an editing item of text content as an example), so that the user edits the cover content of the first type in the candidate cover.
S204: setting a first candidate cover in the at least one candidate cover as a work cover of the work to be posted, in response to a cover setting operation for the first candidate cover.

In this embodiment, when it is detected that the user triggers the cover saving control 22 on the cover selection page or the cover selection panel (as shown in FIG. 9), the candidate cover corresponding to the cover information 21 as selected in the cover list may be set as the work cover of the work to be posted. When it is detected that the user triggers the cover saving control 22 on the editing page of a candidate cover (as shown in FIG. 10), the candidate cover that is edited on the editing page may be set as the work cover of the work to be posted.
S205: presenting an image selection page of the work to be posted, in response to a cover creation operation, where the image selection page is used for the user to select a first work image of the work to be posted for generating a work cover.

The cover creation operation may be a trigger operation for indicating to present the image selection page, such as an operation for triggering a cover creation control on the cover selection page or the cover selection panel. The image selection page may be used for the user to select a work image of the work to be posted, to create the work cover of the work to be posted based on the selected work image. The first work image may be considered as a work image selected by the user on the image selection page, where the work image is an image of the work to be posted, such as a picture or a video frame of the work to be posted, which may be the same as or different from the second work image.

In this embodiment, when the user does not select a desired candidate cover from the cover list, the work cover of the work to be posted may alternatively be created by performing the cover creation operation.

Specifically, when the cover creation operation is received, for example, when it is detected that the user triggers the cover creation control 23 on the cover selection page or the cover selection panel 40 (as shown in FIG. 2 and FIG. 4), the image selection page of the work to be posted may be displayed, as shown in FIG. 6, so that the user selects, on the image selection page, the first work image that the user wants to use to generate the work cover of the work to be posted.
S206: displaying a second editing page of the first work image, in response to a second editing operation performed on the image selection page, and present a second editing item on the second editing page, where the second editing item is used to edit cover content of a second type.

The second editing operation may be a trigger operation for indicating to display a cover editing page of a work image, such as an operation for triggering a next control on the image selection page. The second editing page may be considered as a cover editing page corresponding to the first work image, where the cover editing page may be used to edit and obtain the work cover of the work to be posted. The second editing item may be an editing item used to edit the cover content of the second type. The cover content of the second type may be set as needed. For example, the cover content of the second type may be template content of the cover, such as a template used to switch the cover. The cover content of the second type and the cover content of the first type may be the same or different types of cover content. Optionally, the cover content of the second type and the cover content of the first type may be different types of cover content, to meet different editing needs of the user when performing cover editing on the work image and the candidate cover to generate the work cover.

In this embodiment, when the second editing operation for a work image is received, the second editing page corresponding to the work image may be displayed, and the second editing item used to edit the cover content of the second type in the cover may be presented on the second editing page.

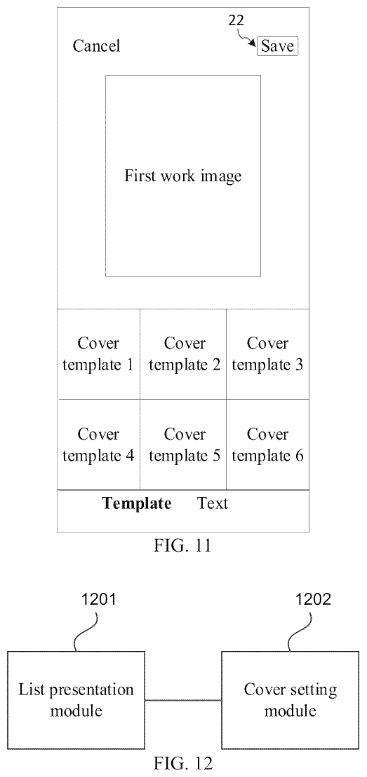

For example, when it is detected that the user triggers a Next control 62 (as shown in FIG. 6) on the image selection page, the work image selected by the user on the image selection page may be used as the first work image, the current page may be switched from the image selection page to the second editing page of the first work image, and the second editing item may be presented on the second editing page, as shown in FIG. 11 (this figure takes the second editing item being an editing item of the cover template as an example), so that the user edits the cover content of the second type in the first work image.

The cover setting method provided in this embodiment supports the user in further editing the candidate cover to obtain the work cover of the work to be posted, and/or in editing the work image to obtain the work cover of the work to be posted, which can further enrich work cover generation manners, and meet different needs of the user.

FIG. 12 is a structural block diagram of a cover setting apparatus according to embodiments of the present disclosure. The apparatus may be implemented by software and/or hardware, and may be configured in an electronic device, typically in a mobile phone or a tablet computer. A cover setting method may be provided to set a cover for a work to be posted. As shown in FIG. 12, the cover setting apparatus provided in this embodiment may include: a list presentation module 1201 and a cover setting module 1202, where
the list presentation module 1201 is configured to present a cover list of a work to be posted, where the cover list presents cover information of at least one candidate cover that is obtained by performing image processing on at least part of work images of the work to be posted; and
the cover setting module 1202 is configured to set a first candidate cover in the at least one candidate cover as a work cover of the work to be posted, in response to a cover setting operation for the first candidate cover.

According to the cover setting apparatus provided in this embodiment, the cover list of the work to be posted is presented by the list presentation module, the cover list presents the cover information of the at least one candidate cover obtained by preforming image processing on at least part of the work images of the work to be posted; and the first candidate cover in the at least one candidate cover is set by the cover setting module as the work cover of the work to be posted, in response to the cover setting operation for the first candidate cover. In this embodiment, the above-described technical solution is used to provide the candidate cover that is obtained by performing image processing on the work images for the user to select, which can simplify operations needed for cover setting, reduce the difficulty of cover setting, and improve the quality of the set cover.

Further, the cover setting apparatus provided in this embodiment further includes at least one selected from a group consisting of the following: a cover selection module configured to present, after the presenting a cover list of a work to be posted, cover information of a second candidate cover in the at least one candidate cover as selected, in response to a selection operation for the second candidate cover, and present a preview image of the second candidate cover in an associated area of the cover list; a cover editing module configured to display, after the presenting a cover list of a work to be posted, a first editing page of a third candidate cover in the at least one candidate cover, in response to a first editing operation for the third candidate cover, and present a first editing item on the first editing page, where the first editing item is used to edit cover content of a first type; or a cover creation module configured to present, after the presenting a cover list of a work to be posted, an image selection page of the work to be posted, in response to a cover creation operation, where the image selection page is used for the user to select a first work image of the work to be posted for generating a work cover.

Further, the cover setting apparatus provided in this embodiment may further include: an image editing module configured to display, after the presenting an image selection page of the work to be posted, a second editing page of the first work image, in response to a second editing operation performed on the image selection page, and present a second editing item on the second editing page, where the second editing item is used to edit cover content of a second type.

In the above-described solution, the list presentation module 1201 may include at least one selected from a group consisting of the following: a first presentation unit configured to display a cover selection page of the work to be posted, and present the cover list of the work to be posted on the cover selection page; or a second presentation unit configured to present the cover list of the work to be posted on a posting page of the work to be posted.

In the above-described solution, the posting page may further present posting information of the work to be posted, and the cover list and the posting information may be presented in different areas or on different layers of the posting page.

In the above-described solution, the first presentation unit may be configured to: display the posting page of the work to be posted; and switch a current page from the posting page to the cover selection page of the work to be posted, in response to a first trigger operation performed on the posting page.

In the above-described solution, the second presentation unit may be configured to: display the posting page of the work to be posted, and present the cover list of the work to be posted on the posting page of the work to be posted, in response to a second trigger operation performed on the posting page; or, display the posting page of the work to be posted, in response to a display operation for the posting page of the work to be posted, and present the cover list of the work to be posted on the posting page of the work to be posted.

In the above-described solution, the list presentation module 1201 may be configured to: display the posting page of the work to be posted, and present a fourth candidate cover from the cover list in a work cover area of the posting page.

In the above-described solution, the list presentation module 1201 may be configured to: present the cover list of the work to be posted, and present image information of a second work image of the work to be posted and the cover information of the at least one candidate cover in the cover list, where the image information of the second work image is used for a user to set the second work image as the work cover of the work to be posted, and cover information of the fourth candidate cover is presented as selected in the cover list.

The cover setting apparatus provided in this embodiment of the present disclosure can perform the cover setting method provided in any embodiment of the present disclosure, and has corresponding functional modules and beneficial effects for performing the cover setting method. For technical details not described in detail in this embodiment, reference may be made to the cover setting method provided in any embodiment of the present disclosure.

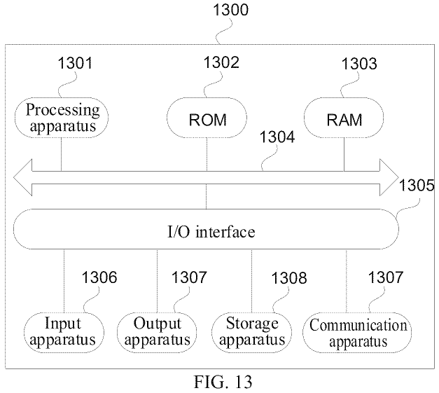

Reference is made to FIG. 13 below, which is a schematic structural diagram of an electronic device (such as a terminal device) 1300 suitable for implementing embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 13 is merely an example, and shall not impose any limitation on the function and scope of use of the embodiments of the present disclosure.

As shown in FIG. 13, the electronic device 1300 may include a processing apparatus (for example, a central processing unit or a graphics processing unit) 1301 that may perform a variety of appropriate actions and processing in accordance with a program stored in a read-only memory (ROM) 1302 or a program loaded from a storage apparatus 1308 into a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touchscreen, a touchpad, a keyboard, a mouse, a camera, a microphone, an accelerometer, and a gyroscope; an output apparatus 1307 including, for example, a liquid crystal display (LCD), a speaker, and a vibrator; the storage apparatus 1308 including, for example, a tape and a hard disk; and a communication apparatus 1309. The communication apparatus 1309 may allow the electronic device 1300 to perform wireless or wired communication with other devices to exchange data. Although FIG. 13 shows the electronic device 1300 having various apparatuses, it should be understood that it is not required to implement or have all of the shown apparatuses. It may be an alternative to implement or have more or fewer apparatuses.

In particular, according to embodiments of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 1309 and installed, installed from the storage apparatus 1308, or installed from the ROM 1302. When the computer program is executed by the processing apparatus 1301, the above-described functions defined in the method of the embodiment of the present disclosure are performed.

It should be noted that the above-described computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above-described computer-readable medium may be contained in the above-described electronic device. Alternatively, the computer-readable medium may exist independently, without being assembled into the electronic device.

The above-described computer-readable medium carries one or more programs that, when executed by the electronic device, cause the electronic device to: present a cover list of a work to be posted, where the cover list presents cover information of at least one candidate cover that is obtained by performing image processing on at least part of work images of the work to be posted; and set a first candidate cover in the at least one candidate cover as a work cover of the work to be posted, in response to a cover setting operation for the first candidate cover.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides a cover setting method. The cover setting method includes:
presenting a cover list of a work to be posted, where the cover list presents cover information of at least one candidate cover that is obtained by performing image processing on at least part of work images of the work to be posted; and
setting a first candidate cover in the at least one candidate cover as a work cover of the work to be posted, in response to a cover setting operation for the first candidate cover.

According to one or more embodiments of the present disclosure, Example 2 provides the method according to Example 1, where after the presenting the cover list of the work to be posted, the method further includes at least one selected from a group consisting of the following:
presenting cover information of a second candidate cover in the at least one candidate cover as selected, in response to a selection operation for the second candidate cover, and presenting a preview image of the second candidate cover in an associated area of the cover list;
displaying a first editing page of a third candidate cover in the at least one candidate cover, in response to a first editing operation for the third candidate cover, and presenting a first editing item on the first editing page, where the first editing item is used to edit cover content of a first type; or
presenting an image selection page of the work to be posted, in response to a cover creation operation, where the image selection page is used for a user to select a first work image of the work to be posted for generating a work cover.

According to one or more embodiments of the present disclosure, Example 3 provides the method according to Example 2, where after the presenting the image selection page of the work to be posted, the method further includes:
displaying a second editing page of the first work image, in response to a second editing operation performed on the image selection page, and presenting a second editing item on the second editing page, where the second editing item is used to edit cover content of a second type.

According to one or more embodiments of the present disclosure, Example 4 provides the method according to Example 1, where the presenting the cover list of the work to be posted includes at least one selected from a group consisting of the following:
displaying a cover selection page of the work to be posted, and presenting the cover list of the work to be posted on the cover selection page; or
presenting the cover list of the work to be posted on a posting page of the work to be posted.

According to one or more embodiments of the present disclosure, Example 5 provides the method according to Example 4, where the posting page further presents posting information of the work to be posted, and the cover list and the posting information are presented in different areas or on different layers of the posting page.

According to one or more embodiments of the present disclosure, Example 6 provides the method according to Example 4, where the displaying the cover selection page of the work to be posted includes:
displaying the posting page of the work to be posted; and
switching a current page from the posting page to the cover selection page of the work to be posted, in response to a first trigger operation performed on the posting page.

According to one or more embodiments of the present disclosure, Example 7 provides the method according to Example 4, where the presenting the cover list of the work to be posted on the posting page of the work to be posted includes:
displaying the posting page of the work to be posted, and presenting the cover list of the work to be posted on the posting page of the work to be posted, in response to a second trigger operation performed on the posting page; or
displaying the posting page of the work to be posted, in response to a display operation for the posting page of the work to be posted, and presenting the cover list of the work to be posted on the posting page of the work to be posted.

According to one or more embodiments of the present disclosure, Example 8 provides the method according to Example 6 or 7, where the displaying the posting page of the work to be posted includes:
display the posting page of the work to be posted, and present a fourth candidate cover from the cover list in a work cover area of the posting page.

According to one or more embodiments of the present disclosure, Example 9 provides the method according to Example 8, where the presenting the cover list of the work to be posted includes:
presenting the cover list of the work to be posted, and presenting image information of a second work image of the work to be posted and the cover information of the at least one candidate cover in the cover list, where the image information of the second work image is used for a user to set the second work image as the work cover of the work to be posted, and cover information of the fourth candidate cover is presented as selected in the cover list.

According to one or more embodiments of the present disclosure, Example 10 provides a cover setting apparatus. The cover setting apparatus includes:
a list presentation module configured to present a cover list of a work to be posted, where the cover list presents cover information of at least one candidate cover that is obtained by performing image processing on at least part of work images of the work to be posted; and
a cover setting module configured to set a first candidate cover in the at least one candidate cover as a work cover of the work to be posted, in response to a cover setting operation for the first candidate cover.

According to one or more embodiments of the present disclosure, Example 11 provides an electronic device. The electronic device includes:
one or more processors; and
a memory configured to store one or more programs, where
the one or more programs, when executed by the one or more processors, cause the one or more processors to implement the cover setting method according to any one of Examples 1 to 9.

According to one or more embodiments of the present disclosure, Example 12 provides a computer-readable storage medium storing a computer program, where the program, when executed by a processor, causes the processor to implement the cover setting method according to any one of Examples 1 to 9.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A cover setting method, comprising:
presenting a cover list of a work to be posted, wherein the cover list presents cover information of at least one candidate cover that is obtained by performing image processing on at least part of work images of the work to be posted; and
setting a first candidate cover in the at least one candidate cover as a work cover of the work to be posted, in response to a cover setting operation for the first candidate cover.

2. The method according to claim 1, wherein after the presenting the cover list of the work to be posted, the method further comprises at least one selected from a group consisting of the following:
presenting cover information of a second candidate cover in the at least one candidate cover as selected, in response to a selection operation for the second candidate cover, and presenting a preview image of the second candidate cover in an associated area of the cover list;
displaying a first editing page of a third candidate cover in the at least one candidate cover, in response to a first editing operation for the third candidate cover, and presenting a first editing item on the first editing page, wherein the first editing item is used to edit cover content of a first type; and
presenting an image selection page of the work to be posted, in response to a cover creation operation, wherein the image selection page is used for a user to select a first work image of the work to be posted for generating a work cover.

3. The method according to claim 2, wherein after the presenting the image selection page of the work to be posted, the method further comprises:
displaying a second editing page of the first work image in response to a second editing operation performed on the image selection page, and presenting a second editing item on the second editing page, wherein the second editing item is used to edit cover content of a second type.

4. The method according to claim 1, wherein the presenting the cover list of the work to be posted comprises at least one selected from a group consisting of the following:
displaying a cover selection page of the work to be posted, and presenting the cover list of the work to be posted on the cover selection page; or
presenting the cover list of the work to be posted on a posting page of the work to be posted.

5. The method according to claim 4, wherein the posting page further presents posting information of the work to be posted, and the cover list and the posting information are presented in different areas or on different layers of the posting page.

6. The method according to claim 4, wherein the displaying the cover selection page of the work to be posted comprises:
displaying the posting page of the work to be posted; and
switching a current page from the posting page to the cover selection page of the work to be posted, in response to a first trigger operation performed on the posting page.

7. The method according to claim 4, wherein the presenting the cover list of the work to be posted on the posting page of the work to be posted comprises:
displaying the posting page of the work to be posted, and presenting the cover list of the work to be posted on the posting page of the work to be posted, in response to a second trigger operation performed on the posting page; or
displaying the posting page of the work to be posted, in response to a display operation for the posting page of the work to be posted, and presenting the cover list of the work to be posted on the posting page of the work to be posted.

8. The method according to claim 6, wherein the displaying the posting page of the work to be posted comprises:
displaying the posting page of the work to be posted, and presenting a fourth candidate cover from the cover list in a work cover area of the posting page.

9. The method according to claim 8, wherein the presenting the cover list of the work to be posted comprises:
presenting the cover list of the work to be posted, and presenting image information of a second work image of the work to be posted and the cover information of the at least one candidate cover in the cover list, wherein the image information of the second work image is used for a user to set the second work image as the work cover of the work to be posted, and cover information of the fourth candidate cover is presented as selected in the cover list.

10. (canceled)

11. An electronic device, comprising:
at least one processor; and
a memory communicatively connected to the at least one processor, wherein
the memory stores a computer program executable by the at least one processor, and the computer program, when executed by the at least one processor, causes the at least one processor to perform:
presenting a cover list of a work to be posted, wherein the cover list presents cover information of at least one candidate cover that is obtained by performing image processing on at least part of work images of the work to be posted; and
setting a first candidate cover in the at least one candidate cover as a work cover of the work to be posted, in response to a cover setting operation for the first candidate cover.

12. A computer-readable storage medium storing computer instructions, wherein the computer instructions, when executed by a processor, cause the processor to implement:
presenting a cover list of a work to be posted, wherein the cover list presents cover information of at least one candidate cover that is obtained by performing image processing on at least part of work images of the work to be posted; and
setting a first candidate cover in the at least one candidate cover as a work cover of the work to be posted, in response to a cover setting operation for the first candidate cover.

13. The method according to claim 7, wherein the displaying the posting page of the work to be posted comprises:
displaying the posting page of the work to be posted, and presenting a fourth candidate cover from the cover list in a work cover area of the posting page.

14. The electronic device according to claim 11, wherein after the presenting the cover list of the work to be posted, the computer program further causes the at least one processor to perform at least one selected from a group consisting of the following:
presenting cover information of a second candidate cover in the at least one candidate cover as selected, in response to a selection operation for the second candidate cover, and presenting a preview image of the second candidate cover in an associated area of the cover list;
displaying a first editing page of a third candidate cover in the at least one candidate cover, in response to a first editing operation for the third candidate cover, and presenting a first editing item on the first editing page, wherein the first editing item is used to edit cover content of a first type; and
presenting an image selection page of the work to be posted, in response to a cover creation operation, wherein the image selection page is used for a user to select a first work image of the work to be posted for generating a work cover.

15. The electronic device according to claim 14, wherein after the presenting the image selection page of the work to be posted, the computer program further causes the at least one processor to perform:
displaying a second editing page of the first work image in response to a second editing operation performed on the image selection page, and presenting a second editing item on the second editing page, wherein the second editing item is used to edit cover content of a second type.

16. The electronic device according to claim 11, wherein the presenting the cover list of the work to be posted comprises at least one selected from a group consisting of the following:
displaying a cover selection page of the work to be posted, and presenting the cover list of the work to be posted on the cover selection page; or
presenting the cover list of the work to be posted on a posting page of the work to be posted.

17. The electronic device according to claim 16, wherein the displaying the cover selection page of the work to be posted comprises:
displaying the posting page of the work to be posted; and
switching a current page from the posting page to the cover selection page of the work to be posted, in response to a first trigger operation performed on the posting page.

18. The electronic device according to claim 16, wherein the presenting the cover list of the work to be posted on the posting page of the work to be posted comprises:
displaying the posting page of the work to be posted, and presenting the cover list of the work to be posted on the posting page of the work to be posted, in response to a second trigger operation performed on the posting page; or
displaying the posting page of the work to be posted, in response to a display operation for the posting page of the work to be posted, and presenting the cover list of the work to be posted on the posting page of the work to be posted.

19. The computer-readable storage medium according to claim 12, wherein after the presenting the cover list of the work to be posted, the computer instructions further cause the processor to implement at least one selected from a group consisting of the following:
presenting cover information of a second candidate cover in the at least one candidate cover as selected, in response to a selection operation for the second candidate cover, and presenting a preview image of the second candidate cover in an associated area of the cover list;
displaying a first editing page of a third candidate cover in the at least one candidate cover, in response to a first editing operation for the third candidate cover, and presenting a first editing item on the first editing page, wherein the first editing item is used to edit cover content of a first type; and
presenting an image selection page of the work to be posted, in response to a cover creation operation, wherein the image selection page is used for a user to select a first work image of the work to be posted for generating a work cover.

20. The computer-readable storage medium according to claim 19, wherein after the presenting the image selection page of the work to be posted, the computer instructions further cause the processor to implement:
displaying a second editing page of the first work image in response to a second editing operation performed on the image selection page, and presenting a second editing item on the second editing page, wherein the second editing item is used to edit cover content of a second type.

21. The computer-readable storage medium according to claim 12, wherein the presenting the cover list of the work to be posted comprises at least one selected from a group consisting of the following:
displaying a cover selection page of the work to be posted, and presenting the cover list of the work to be posted on the cover selection page; or
presenting the cover list of the work to be posted on a posting page of the work to be posted.
